(19) United States
(12) Patent Application Publication
(10) Pub. No.: US 2009/0216388 A1
(43) Pub. Date: Aug. 27, 2009

(54) WAFER AND TEMPERATURE TESTING METHOD OF THE SAME

(76) Inventor: Hiroo Ito, Tokyo (JP)

Correspondence Address: NEC CORPORATION OF AMERICA, 6535 N. STATE HWY 161, IRVING, TX, 75039, US

(21) Appl. No.: 12/389,622

(22) Filed: Feb. 20, 2009

(30) Foreign Application Priority Data
Feb. 21, 2008 (JP) 2008-040684

(51) Int. Cl. G05D 23/00

(52) U.S. Cl. 700/299

(57) ABSTRACT

A wafer on which a plurality of semiconductor chips are formed, and the wafer includes a temperature control circuit embedded in the wafer and configured to control its periphery temperature in the wafer to a predetermined target temperature; and a pad to which a start signal is supplied to start the thermal control circuit. The temperature control circuit is started in response to the start signal to automatically perform a temperature control without receiving any control signal.

### INCORPORATION BY REFERENCE

This patent application claims priority on convention based on Japanese Patent Application No. 2008-040684, filed Feb. 21, 2008. The disclosure thereof is incorporated herein by reference.

### TECHNICAL FIELD

The present invention relates to a temperature test of a semiconductor device. More particularly, the present invention relates to a temperature test of a wafer on which a plurality of semiconductor chips are formed.

### BACKGROUND ART

As a reliability test for improving the product reliability of a semiconductor device, a burn-in test is known. The burn-in test is an acceleration test that the semiconductor device is operated under the environment of a high temperature and a high voltage to apply a stress stricter than that of an actual use state. Consequently, an initial failure and a fault in a manufacturing process can be discovered in a short time. As a result, a market failure rate is reduced, and the product reliability is maintained.

In the temperature test of the burn-in test or the like, it is important to keep the semiconductor device at a predetermined temperature. As the technique related to a temperature control of the semiconductor device, the followings are known.

Japanese Patent Application Publication (JP-P 2004-286691A) describes a semiconductor device for a temperature test. This semiconductor device contains a temperature difference detecting section, a control section and a heating circuit. The temperature difference detecting section contains a temperature detecting circuit and an input terminal to which a temperature setting voltage is supplied. The difference between the output voltage of the temperature detecting circuit and the temperature setting voltage supplied from an external unit is outputted to a control section. The control section converts the difference into a ratio of the ON and OFF times of the heating circuit and controls a heating circuit. Thus, in the temperature test, the temperature can be controlled at a high precision in a range between a usual temperature region and a high temperature region.

Japanese Patent Application Publication (JP-P2007-240263A) describes a semiconductor integrated circuit in which an operation test can be performed at a high precision even if an operation guarantee temperature is set high. The semiconductor integrated circuit contains an input/output circuit, a plurality of heating circuits, a first pad to which a control signal is supplied to control the heating circuit, a second pad for outputting a signal detected by a temperature sensor to an external unit, and a decoder. The input/output circuit is connected to the pads arranged at a predetermined interval on a semiconductor substrate and contains an input/output buffer. The heating circuit is arranged in the vicinity of the input/output circuit. The control circuit contained in an evaluating tool generates a control signal in accordance with the signal detected by the temperature sensor. The decoder decodes the control signal and selects the heating circuit to be operated in accordance with a decoded result, in units of blocks.

Japanese Patent Application Publication (JP-P2000-340623A) describes a technique for collectively performing BIST (Built-In Self Test) to all semiconductor chips on a wafer. Each semiconductor chip contains an internal circuit, a temperature detecting circuit, a BIST circuit, and an input pad. In the course of the test, a monitor input signal is supplied to the input pad of each semiconductor chip. The monitor input signal is a signal indicating whether or not the peripheral chips are being tested. If the temperature detecting circuit detects an abnormal temperature, the BIST circuit temporarily stops a self-test only for a predetermined waiting time and suppresses a heat generation quantity of the chip. At this time, a period of the temporary stop is determined by referring to the monitor input signal and considering the test situation of the peripheral chip.

In the temperature test of the burn-in test or the like, the temperature test is desired to be performed in a wafer level, in order to make the test time short. At this time, it is important to keep the wafer, on which many semiconductor chips are formed, at a predetermined temperature. However, when the above related arts are applied to the wafer, connection between the many semiconductor chips on the wafer and an external control unit becomes complicated and enormous. The complicated enormous connection leads to the increase in a facility cost.

### DISCLOSURE OF INVENTION

The present invention provides a wafer on which a plurality of semiconductor chips and a temperature test method of the wafer, in which a temperature control circuit embedded in the wafer control its periphery temperature to a predetermined target temperature in response to only once supply of an instruction.

In a first aspect of the present invention, a wafer on which a plurality of semiconductor chips are formed, and the wafer includes a temperature control circuit embedded in the wafer and configured to control its periphery temperature in the wafer to a predetermined target temperature; and a pad to which a start signal is supplied to start the thermal control circuit. The temperature control circuit is started in response to the start signal to automatically perform a temperature control without receiving any control signal.

Also, in a second aspect of the present invention, a semiconductor chip includes a temperature control circuit configured to control its periphery temperature to a predetermined target temperature; and a pad to which a start signal is supplied to start the temperature control circuit. The temperature control circuit is started in response to the start signal to automatically perform a temperature control without receiving any control signal.

Also, a third aspect of the present invention, a temperature testing method of a wafer on which a plurality of semiconductor chips are formed is provided. A temperature control circuit is embedded in the wafer to control its periphery temperature to a predetermined target temperature. The temperature testing method includes starting the temperature control circuit in response to a start signal; and automatically controlling a temperature of the wafer to the target temperature without receiving any control signal by using the temperature control circuit.

According to the present invention, the temperature control circuit is embedded in the wafer to control the temperature. The temperature control circuit automatically controls the temperature of the wafer without receiving another control signal after it is started in response to a start signal. In other words, a temperature control process is completed inside the wafer, and with only the reception of the start signal, the wafer temperature is automatically controlled to a predetermined target temperature. The temperature control data is not required to be sequentially supplied. Also, the complicated connection between many signal terminals of the respective chips and the external control circuit is not required. Thus, the temperature test in the wafer level can be executed without any increase in the facility cost.

### BRIEF DESCRIPTION OF THE DRAWINGS

The above and other objects, advantages and features of the present invention will be more apparent from the following description of certain exemplary embodiments taken in conjunction with the accompanying drawings, in which:

FIG. 1 is a conceptual view showing a wafer according to an exemplary embodiment of the present invention;

FIG. 2 is a block diagram showing a configuration of a temperature control circuit according to the present invention;

FIG. 3 is a circuit diagram showing one example of a temperature detecting circuit according to the present invention;

FIG. 4 is a circuit diagram showing one example of a heating circuit according to the present invention;

FIG. 5 is a conceptual diagram showing a wafer according to a first exemplary embodiment of the present invention;

FIG. 6 is a block diagram schematically showing one example of a configuration of an IC chip in the first exemplary embodiment;

FIG. 7 is a block diagram schematically showing another example of the configuration of the IC chip in the first exemplary embodiment;

FIG. 8 is a block diagram schematically showing still another example of the configuration of the IC chip in the first exemplary embodiment;

FIG. 9 is a conceptual diagram showing the wafer at the time of the temperature test;

FIG. 10 is a conceptual diagram showing a wafer according to a second exemplary embodiment of the present invention; and

FIG. 11 is a block diagram showing a configuration of a temperature control circuit according to a third exemplary embodiment of the present invention.

### EXEMPLARY EMBODIMENTS

Hereinafter, the present invention will be described below with reference to the attached drawings.

### 1. Outline

According to the present invention, a temperature test is performed in a wafer level. At the time of the temperature test, a wafer temperature is kept at a predetermined target temperature. In the present invention, a mechanism for controlling the wafer temperature at the time of the temperature test is formed in the wafer itself in advance.

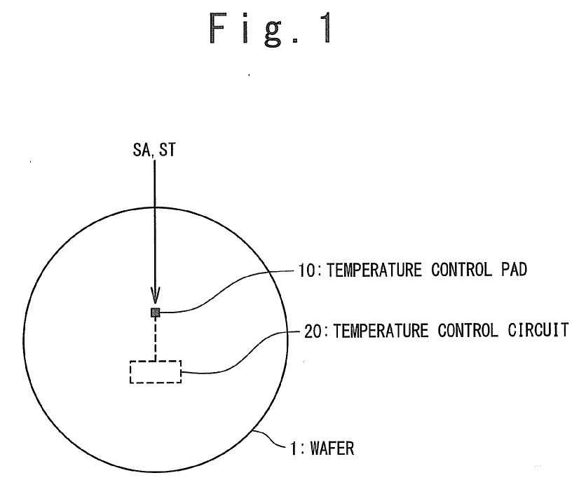

FIG. 1 conceptually shows a wafer 1 according to the present invention. A plurality of IC chips (semiconductor chips), which are not shown, are formed on the wafer 1. Moreover, a temperature control pad 10 and a temperature control circuit 20 are formed on the wafer 1. The temperature control circuit 20 is embedded in the wafer 1 and electrically connected to the temperature control pad 10 formed on the wafer 1.

A start signal SA for starting the temperature control circuit 20 and an end signal ST for stopping the operation of the temperature control circuit 20 are supplied to the temperature control pad 10 from an external unit. The start signal SA or end signal ST is sent from the temperature control pad 10 to the temperature control circuit 20.

The temperature control circuit 20 controls a temperature of a peripheral portion of the circuit 20 to be kept at a predetermined target temperature at the time of temperature test. In detail, at the time of the temperature test, the start signal SA is supplied through the temperature control pad 10 to the temperature control circuit 20. The temperature control circuit 20 is started in response to the start signal SA and automatically controls the temperature of the peripheral portion. For the sake of this temperature control process, the temperature control circuit 20 does not require additional temperature control data and temperature control signals. That is, after being started in response to the start signal SA, the temperature control circuit 20 automatically controls the temperature of the peripheral portion without receiving any control signal until the reception of the end signal ST. In other words, the whole of temperature control process is completed inside the wafer 1. In response to only the supply of the start signal SA, the wafer temperature is automatically controlled to the predetermined target temperature.

In this way, according to the present invention, the temperature control of the wafer 1 can be easily attained in response to the supply of the start signal SA through the temperature control pad 10. Any special heat source is not required to be separately prepared. Moreover, the temperature control data from an external unit is not required to be sequentially supplied, and the complicated connection between many signal terminals of the respective IC chips and the external unit is not required. The necessary configuration is only the connection between the temperature control pad 10 and the external unit for generating the start signal SA and the end signal ST. Thus, the temperature test in the wafer level can be performed without any increase in the facility cost.

The present invention can be applied to an aging operation of the IC chip. In recent years, a 45-nm process has been vigorously developed. However, in such a device with a fine structure, stress applied to an interconnection and a via-hole, especially, the stress having a temperature dependence is significant, as compared with a conventional device. For example, with regard to a Cu interconnection, stress in an interconnection direction caused due to the migration of Cu and tensile stress between the Cu interconnection and an oxide film have a temperature dependence. It is known that a fault of the interconnection that is caused due to those stresses is significant in case of 70° C. or more. In short, even if it is not operated under the condition of use of a high voltage, the deterioration of interconnection progresses by placing the device under a high temperature. The present invention can be applied to an interconnection test under such a high temperature condition.

Of course, the present invention can be applied to even the usual burn-in test. In that case, together with the temperature control by the temperature control circuit 20 according to the present invention, an original operation of the semiconductor chip is performed under the high voltage. In any case, the temperature test in the wafer level can be easily performed.

### 2. Temperature Control Circuit

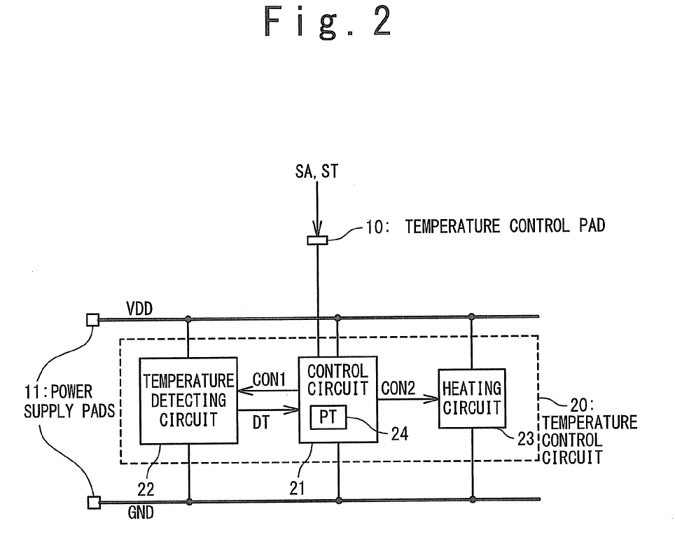

One example of the temperature control circuit 20 according to the present invention will be described below in detail. As shown in FIG. 2, the temperature control circuit 20 includes a control circuit 21, a temperature detecting circuit 22 and a heating circuit 23. Among them, the control circuit 21 is connected to the temperature control pad 10. Also, the control circuit 21, the temperature detecting circuit 22 and the heating circuit 23 are connected to a power supply line and a ground line. The power supply line and the ground line are connected to power supply pads 11 to which a power supply voltage VDD and a ground voltage GND are supplied.

The control circuit 21 is a circuit for controlling the operation of the temperature control circuit 20 and is started in response to the start signal SA. The temperature detecting circuit 22 is a circuit for detecting (measuring) the temperature of the peripheral portion in response to an instruction from the control circuit 21. The heating circuit 23 is a heat source for generating heat in accordance with an instruction from the control circuit 21.

When the start signal SA is supplied from the temperature control pad 10, the control circuit 21 is started. The control circuit 21 outputs an internal control signal CON1 to instruct the temperature detection to the temperature detecting circuit 22. The temperature detecting circuit 22 measures (detects) the temperature in the peripheral portion of the temperature control circuit 20 in the wafer in response to the internal control signal CON1 from the control circuit 21, and outputs a detection temperature data DT indicative of the detected temperature to the control circuit 21. The control circuit 21 compares the detection temperature data DT with a predetermined target temperature and outputs an internal control signal CON2 to the heating circuit 23 in response to the comparison result. If the detection temperature of the data DT is lower than the target temperature, the internal control signal CON2 instructs the heating circuit 23 to start the heat generation. On the other hand, if the detected temperature is higher than the target temperature, the internal control signal CON2 instructs the heating circuit 23 to stop the heat generation. The heating circuit 23 generates the heat in response to the internal control signal CON2 from the control circuit 21 or stops the heat generation. The temperature detecting circuit 22 detects or measures the temperature of the peripheral portion intermittently or continuously and outputs the detection temperature data DT indicative of the detected temperature to the control circuit 21. The control circuit 21 generates the internal control signal CON2 each time receiving of the detection temperature data DT and controls the operation of the heating circuit 23. In this way, the control circuit 21 controls ON/OFF of the heating circuit 23 so that the temperature measured by the temperature detecting circuit 22 becomes the predetermined target temperature. After that, when the end signal ST is supplied from the temperature control pad 10, the control circuit 21 stops the operations of the temperature detecting circuit 22, the heating circuit 23 and the control circuit 21 itself.

In detail, the control circuit 21 includes a storage circuit 24 for storing a data PT indicative of the target temperature. The target temperature data PT is a digital data that indicates the predetermined target temperature (for example, 130° C.). The storage circuit 24 is a ROM (Read Only Memory) to which the target temperature data PT is written at the time of a manufacturing process. Or, the storage circuit 24 may be a fuse circuit provided with a plurality of electrical fuses. In this case, by supplying a current to the fuse circuit from predetermined set terminals, it is possible to variably set the target temperature data PT. Or, the storage circuit 24 may be a register circuit provided with flip-flop circuits. The flip-flop circuits are assembled in a scanning chain, and the target temperature data PT can be set through the scanning chain from a predetermined set terminal. It should be noted that even in any case, the target temperature is set in advance prior to the temperature test. In short, when the start signal SA is supplied, the storage circuit 24 is in the state in which the target temperature data PT is already stored therein. At the time of the temperature test, the control circuit 21 compares the detection temperature data DT received from the temperature detecting circuit 22 and the target temperature data PT stored in the storage circuit 24. Then, in accordance with the comparison result, the control circuit 21 outputs the internal control signal CON2 to the heating circuit 23. Such a control circuit 21 can be attained by a small micro computer.

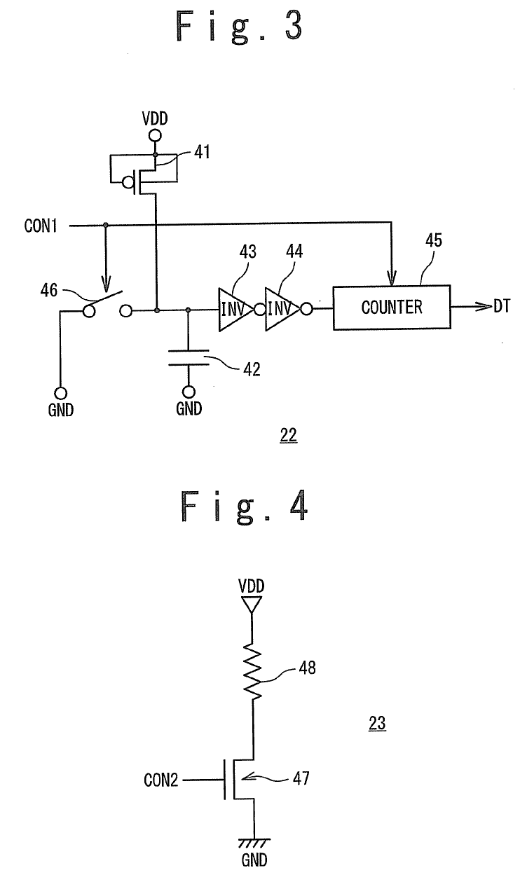

FIG. 3 shows one example of the temperature detecting circuit 22. In the example in FIG. 3, the circuit configuration is simplified or partially omitted. The temperature detecting circuit 22 includes a current source 41, a capacitor 42, inverters 43 and 44, a counter 45 and a switch 46. The current source 41 is a semiconductor device whose output current is changed in accordance with a temperature change and functions as a temperature sensor for detecting the temperature. For example, the current source 41 includes a MOS transistor whose device parameters are already known. In this case, as the output current that is changed in accordance with the temperature change, an off leak current Ioff of the MOS transistor is used.

The operation of the temperature detecting circuit 22 has been described in PCT Application No. PCT/JP2008/071549 corresponding to Japanese Patent Application No. 2007-340361 in detail. The disclosure thereof is incorporated herein by reference.

Here, the operation of the temperature detecting circuit 22 will be described briefly. The capacitor 42, the inverters 43 and 44, the counter 45 and the switch 46 constitute a current reading section for detecting the output current from the current source 41. This current reading section can output a digital data (detection temperature data DT) corresponding to the detected output current of the current source 41. That is, the capacitor 42 is charged with the off leak current Ioff from the current source 41. When the capacitance of the capacitor 42 is defined as C and a voltage of the capacitor 42 is defined as Vcharge, its charge time Time is given by Time=C×Vcharge/Ioff. The voltage Vcharge of the capacitor 42 is supplied to the inverter 43. The inverters 43 and 44 buffers the voltage Vcharge of the capacitor while the capacitor voltage Vcharge increases. The operations of the switch 46 and the counter 45 are controlled by the internal control signal CON1 from the control circuit 21. The switch 46 is provided to control the charging/discharging operation of the capacitor 42. When the switch 46 is OFF, the capacitor 42 is charged with the off leak current Ioff. On the other hand, when the switch 46 is ON, the charge stored in the capacitor 42 is discharged. The counter 45 counts a clock signal (not shown) in response to the internal control signal CON1, that is, while the switch 46 is in the OFF state. Thus, the charge time is counted (measured) and the count value is outputted as the temperature data DT.

FIG. 4 shows one example of the heating circuit 23. In an example shown in FIG. 4, the heating circuit 23 includes a MOS transistor 47 and a resistor 48, which are connected in series between the power supply line and the ground line. The internal control signal CON2 is supplied from the control circuit 21 to the gate of the MOS transistor 47. When the internal control signal CON2 is in a “High” level, the MOS transistor 47 is turned ON. As a result, current flows through the resistor 48, and the heat is generated. On the other hand, when the internal control signal CON2 is in a “Low” level, the MOS transistor 47 is turned OFF. As a result, the current flowing through the resistor 48 is shut down, and the heat generation is stopped.

It should be noted that as the MOS transistor 47 of the heating circuit 23, a MOS transistor that is used as a capacitance at a time of a practical use may be used. Typically, in the semiconductor device operating at a high frequency, the MOS transistor functioning as the capacitance at the time of the practical use is provided between the power supply line and the ground line. Since the internal control signal CON2 is supplied to the gate of the MOS transistor at the time of the temperature test, it can be used as the heating circuit. In this case, the heating circuit 23 is not required to be separately installed. Thus, the circuit area can be saved.

As mentioned above, the temperature control circuit 20 automatically controls the temperature so that the peripheral temperature is equal to the predetermined target temperature. At this time, the whole of temperature control process is completed inside the wafer, and the temperature control data is not required to be sequentially supplied from the external unit. The wafer temperature is automatically controlled to the predetermined target temperature through the supply of the start signal SA.

### First Exemplary Embodiment

In the first exemplary embodiment of the present invention, the temperature control circuit 20 is built in each of the plurality of semiconductor chips formed on the wafer 1.

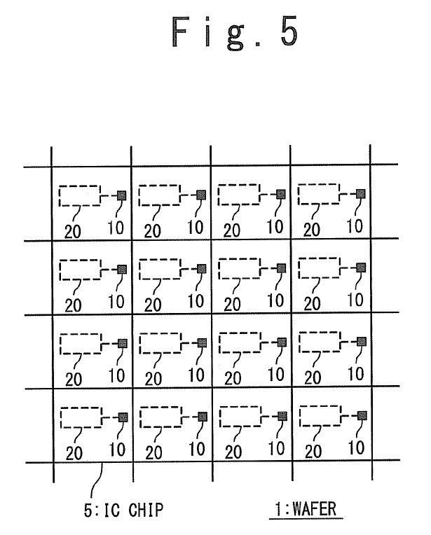

FIG. 5 conceptually shows the wafer 1 according to the first exemplary embodiment. A plurality of IC chips (semiconductor chips) 5 are formed on the wafer 1 in a matrix. The temperature control circuits 20 are embedded in the respective IC chips 5. That is, each of the IC chips 5 has the temperature control pad 10 and the temperature control circuit 20. In this case, since each of the temperature control circuits 20 independently controls the temperature inside each of the IC chips 5, the temperature of the entire wafer 1 is kept at the predetermined target temperature. Since the temperature control circuit 20 is incorporated in each IC chip 5, the wafer temperature can be uniformly controlled.

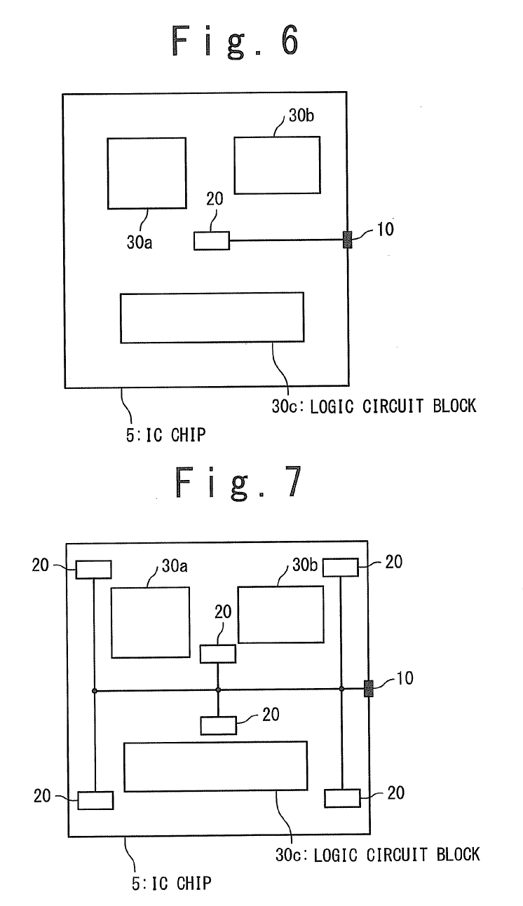

FIG. 6 conceptually shows the configuration example of one IC chip 5. In FIG. 6, the IC chip 5 contains a plurality of logical circuit blocks 30 (30a to 30c). The logical circuit blocks 30 are functional blocks for providing an original function of the IC chip 5. A basic cell such as a NAND and a macro cell such as a RAM are exemplified. The IC chip 5 further contains the temperature control pad 10 and the temperature control circuit 20. The temperature control circuit 20 is connected to the temperature control pad 10 and also arranged near the center of the IC chip 5. This temperature control circuit 20 controls the temperature of a peripheral portion of the circuit 20 in response to the start signal SA supplied through the temperature control pad 10. Thus, the temperature inside the IC chip 5 is controlled to the predetermined target temperature. Also, the plurality of heating circuits 23 may be dispersedly arranged inside one IC chip 5. In that case, the temperature inside the IC chip 5 can be quickly controlled.

It should be noted that power is supplied through the power supply pads 11 (not shown) to the logical circuit blocks 30, and the data and the control signal are supplied through signal input pads (not shown). The logical circuit blocks 30 operate in accordance with those data and control signals. On the other hand, the temperature control circuit 20 operates independently of the logical circuit blocks 30. In the first exemplary embodiment, the temperature control pad 10 to which the start signal SA is supplied is arranged separately from the power supply pads 11 and signal input pads to which the signals are supplied.

FIG. 7 schematically shows another example of the configuration of one IC chip 5. In the example shown in FIG. 7, a plurality of temperature control circuits 20 are built in one IC chip 5. The plurality of temperature control circuits 20 are commonly connected to one temperature control pad 10, and they control the temperatures independently of each other in response to the single start signal SA. Even with such configuration, the temperature inside the IC chip 5 is controlled to the predetermined target temperature. It should be noted that, preferably, the plurality of temperature control circuits 20 are dispersedly arranged inside the IC chips 5. Thus, the temperature inside the IC chip 5 can be quickly controlled.

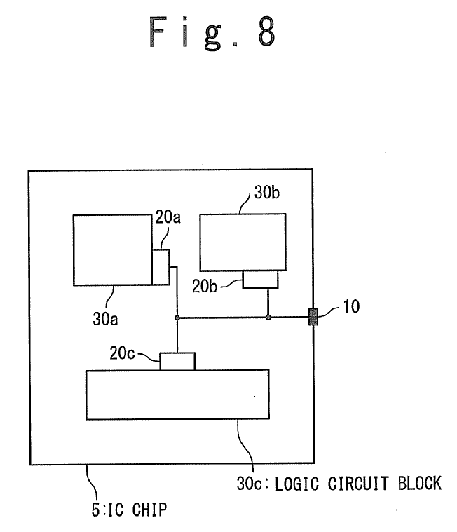

FIG. 8 schematically shows still another example of the configuration of one IC chip 5. In the example in FIG. 8, a plurality of temperature control circuits 20a to 20c are installed adjacently to a plurality of logical circuit blocks 30a to 30c, respectively. In this case, the temperatures of the vicinities of the logical circuit and the interconnection, in which a fault may occur under the high temperature condition, can be detected and controlled, and the temperature control can be performed in a high precision.

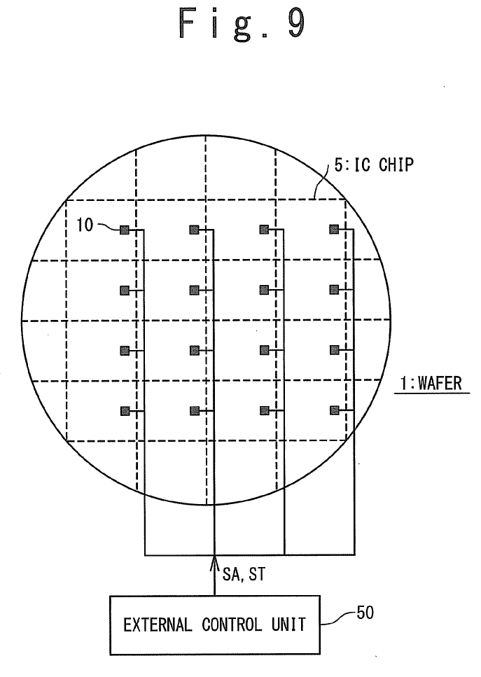

FIG. 9 schematically shows the state of the wafer 1 at the time of the temperature test. For convenience, the illustration of the power supply pads 11 used to supply the power to the IC chip 5 is omitted. As shown in FIG. 9, the wafer 1 is connected to an external control unit 50 for generating and outputting the start signal SA and the end signal ST. In detail, the respective temperature control pads 10 of the plurality of IC chips 5 formed on the wafer 1 are commonly connected to the external control unit 50. Thus, the external control unit 50 can “collectively” supply the start signal SA and the end signal ST to the respective temperature control pads 10 of the plurality of IC chips 5.

At the time of the temperature test, the external control unit 50 firstly outputs the start signal SA. The start signal SA is collectively supplied to the respective temperature control pads 10 in the plurality of IC chips 5. In response to the start signal SA, the temperature control circuits 20 built in the respective IC chips 5 are started at the same time. After being started in response to the start signal SA, the temperature control circuits 20 control the temperatures independently of each other in the respective IC chips 5. At this time, each temperature control circuit 20 automatically controls the temperature without receiving any control signal, until the supply of the end signal ST. As a result, the temperatures inside the plurality of IC chips 5 are controlled to the predetermined target temperature at the same time independently of each other. Thus, the temperature of the entire wafer 1 is kept at the predetermined target temperature. When the temperature test has ended, the external control unit 50 outputs the end signal ST. The end signal ST is collectively supplied to the respective temperature control pads 10 in the plurality of IC chips 5. In response to the end signal ST, the operations of the temperature control circuits 20 built in the respective IC chips 5 are stopped at the same time.

After the temperature test, the wafer 1 is diced, and the respective IC chips 5 are separated. In the first exemplary embodiment, the temperature control circuits 20 are still embedded in the respective IC chips 5. The control circuit 21 in each temperature control circuit 20 may rewrite the target temperature data PT in accordance with the end signal ST and change the target temperature to a lower temperature (for example, 25° C.). Thus, even if the temperature control circuit 20 is accidently started at the time of the practical use, it is possible to avoid the thermal runaway of the IC chip 5. In this case, a register provided with flip-flop circuits is preferable, as the storage circuit 24 in which the target temperature data PT is stored.

### Second Exemplary Embodiment

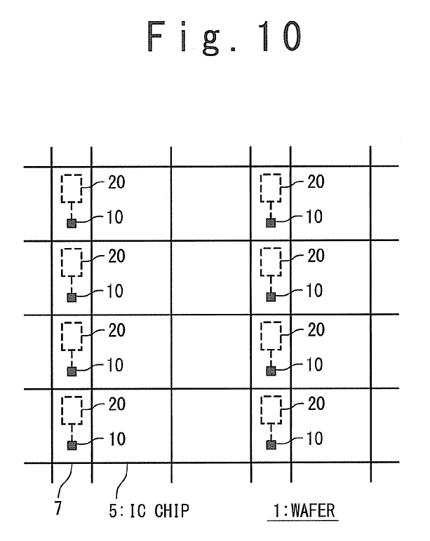

FIG. 10 conceptually shows the wafer 1 according to the second exemplary embodiment of the present invention. In the second exemplary embodiment, the temperature control circuits 20 are provided on the wafer 1 independently of the plurality of IC chips 5. In detail, on the wafer 1, temperature control regions 7 are formed in addition to the plurality of IC chips 5. The temperature control region 7 is a region different from a region for the IC chips 5 and sandwiched between the region for the IC chips 5. In this exemplary embodiment, the temperature control pad 10 and the temperature control circuit 20 are formed in the temperature control region 7. Each IC chip 5 operates apart from the temperature control circuit 20.

In this exemplary embodiment, the heating circuit 23 of the temperature control circuit 20 is formed inside the temperature control region 7, differently from a MOS transistor inside the IC chip 5 that is used as the capacitance at the time of the practical operation. Also, a ROM or a fuse circuit is preferable as the storage circuit 24 of the control circuit 21 in the temperature control circuit 20.

This temperature testing method is similar to the first exemplary embodiment. That is, the external control unit 50 is commonly connected to the temperature control pads 10 on the wafer 1. The start signal SA and the end signal ST, which are outputted from the external control unit 50, are collectively supplied to the temperature control pads 10 on the wafer 1. The temperature control circuits 20 control the temperatures independently of each other. Thus, the temperature of the entire wafer 1 is kept at the predetermined target temperature.

The configuration shown in FIG. 10 is the configuration peculiar to the temperature test of the wafer level. Also, in the second exemplary embodiment, the temperature control circuit 20 does not remain in each IC chip 5, after it is diced. In short, each IC chip 5 after being diced is the same as the usual chip. Thus, the increase in the area of the IC chip 5 is prevented. Moreover, there is no case that at the time of the practical use, the temperature control circuit 20 is erroneously started to cause the thermal runaway of the IC chip 5.

### Third Exemplary Embodiment

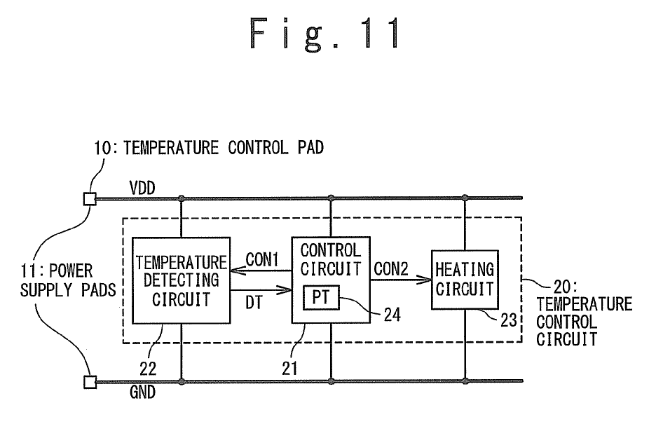

The temperature control circuit 20 may be designed to be automatically started in response to connection of the power supply (Power ON Reset). FIG. 11 shows the configuration example of the temperature control circuit 20 according to the third exemplary embodiment. As shown in FIG. 11, the control circuit 21, the temperature detecting circuit 22 and the heating circuit 23 in the temperature control circuit 20 are connected to the power supply line and the ground line. The power supply line and the ground line are connected to the power supply pads 11 to which the power supply voltage VDD and the ground voltage GND are supplied.

According to this exemplary embodiment, the control circuit 21 in the temperature control circuit 20 is automatically started in response to the supply of the power supply voltage VDD. That is, the temperature control pad 10 is the power supply pad 11 to which the power supply voltage VDD is supplied. Also, the start signal SA is the power supply voltage VDD supplied from the power supply pad 11. Also, the supply of the end signal ST corresponds to the end of the supply of the power supply voltage VDD. The temperature control circuit 20 is automatically started in response to the supply of the power supply voltage VDD and performs the temperature control similar to those of the above-mentioned exemplary embodiments. The temperature control circuit 20 shown in FIG. 11 can be applied to the above-mentioned first exemplary embodiment or second exemplary embodiment.

It should be noted that in this exemplary embodiment, the power supply pads 11 connected to the temperature control circuit 20 are desired not to be connected to any circuits such as the logical circuit block. In short, the power supply pads 11 connected to the temperature control circuit 20 are desired to be used only at the time of the temperature test.

As mentioned above, the exemplary embodiments of the present invention have been described with reference to the attached drawings. However, the present invention is not limited to the above-mentioned exemplary embodiments and may be properly changed in the range without departing from the scope by one skilled in the art.

What is claimed is:

1. A wafer on which a plurality of semiconductor chips are formed, comprising:
a temperature control circuit embedded in said wafer and configured to control its periphery temperature in said wafer to a predetermined target temperature; and
a pad to which a start signal is supplied to start said thermal control circuit,
wherein said temperature control circuit is started in response to the start signal to automatically perform a temperature control without receiving any control signal.

2. The wafer according to claim 1, wherein said temperature control circuit comprises:
a control circuit started in response to said start signal;
a temperature detecting circuit configured to measure the periphery temperature in response to an instruction from said control circuit, and output a measurement temperature data indicating the measured temperature to said control circuit; and
a heating circuit configured to generate heat in an instruction from said control circuit,
wherein said control circuit controls said heating circuit such that the measured temperature by said temperature detecting circuit is the target temperature.

3. The wafer according to claim 2, wherein said control circuit comprises a storage circuit configured to store a data indicating the target temperature,
wherein the target temperature data is stored in said storage circuit prior to the start signal.

4. The wafer according to claim 1, wherein said temperature control circuit and said pad are formed in a region of said wafer other than a region for said plurality of semiconductor chips.

5. The wafer according to claim 1, wherein each of said plurality of semiconductor chips has said pad and said temperature control circuit is provided in each of said plurality of semiconductor chips.

6. The wafer according to claim 5, wherein a temperature of each of said plurality of semiconductor chips is controlled to the target temperature independently of each other.

7. The wafer according to claim 5, wherein a number of said temperature control circuits in said each semiconductor chip is plural.

8. The wafer according to claim 1, wherein said pad is a power supply pad to which a power supply voltage is supplied,
said start signal is the power supply voltage, and
said temperature control circuit is automatically started in response to the supply of the power supply voltage.

9. A semiconductor chip comprises:
a temperature control circuit configured to control its periphery temperature to a predetermined target temperature; and
a pad to which a start signal is supplied to start said temperature control circuit,
wherein said temperature control circuit is started in response to the start signal to automatically perform a temperature control without receiving any control signal.

10. The semiconductor chip according to claim 9, wherein said temperature control circuit comprises:
a control circuit started in response to said start signal;
a temperature detecting circuit configured to measure the periphery temperature in response to an instruction from said control circuit, and output a measurement temperature data indicating the measured temperature to said control circuit; and
a heating circuit configured to generate heat in an instruction from said control circuit,
wherein said control circuit controls said heating circuit such that the measured temperature by said temperature detecting circuit is the target temperature.

11. The semiconductor chip according to claim 10, wherein said control circuit comprises a storage circuit configured to store a data indicating the target temperature,
wherein the target temperature data is stored in said storage circuit prior to the start signal.

12. The semiconductor chip according to claim 9, wherein said temperature control circuit and said pad are formed in a region of a wafer other than a region for said semiconductor chip.

13. The semiconductor chip according to claim 9, wherein a number of said temperature control circuits in said each semiconductor chip is plural.

14. The semiconductor chip according to claim 9, wherein said pad is a power supply pad to which a power supply voltage is supplied,
said start signal is the power supply voltage, and
said temperature control circuit is automatically started in response to the supply of the power supply voltage.

15. A temperature testing method of a wafer on which a plurality of semiconductor chips are formed, wherein a temperature control circuit is embedded in said wafer to control its periphery temperature to a predetermined target temperature, said temperature testing method comprising:
starting said temperature control circuit in response to a start signal; and
automatically controlling a temperature of said wafer to said target temperature without receiving any control signal by using said temperature control circuit.
